(19) United States
(12) Patent Application Publication
(10) Pub. No.: US 2005/0279693 A1
(43) Pub. Date: Dec. 22, 2005

(54) Ceramic filter

(75) Inventors: Masanori Katsu, Nagoya-city (JP); Katsuya Morishima, Kani-gun (JP)

Correspondence Address: STEPTOE & JOHNSON LLP, 1330 CONNECTICUT AVENUE, N.W., WASHINGTON, DC, 20036, US

(73) Assignee: NGK Insulators, Ltd., Nagoya-city (JP)

(21) Appl. No.: 11/151,342

(22) Filed: Jun. 14, 2005

(30) Foreign Application Priority Data
Jun. 22, 2004 (JP) 2004-183413

(51) Int. Cl. B01D 63/06

(52) U.S. Cl. 210/321.87; 210/497.01; 210/510.1; 210/490

(57) ABSTRACT

A ceramic filter comprises a cylindrical porous body having a plurality of parallel flow paths formed in its long axial direction and being provided with plural slit-like aperture portions in its long axial direction and end portions of flow paths communicating with aperture portions are sealed. All slit-like aperture portions are provided at such positions capable of satisfying the relations that the ratio Sn/Qn of opening area Sn (mm²) of each slit-like aperture portion and water permeation amount Qn (m³/day at 0.1 MPa, 25° C.) taken by the aperture portion having the opening area Sn is not less than 1.0 and the ratio D1/Lo of the whole porous body length Lo and the distance D1 which is twice the shortest distance from the center of the porous body in its long axial direction to the end of any one of slit-like aperture portions is not less than 0.5.

### BACKGROUND OF THE INVENTION

1. Field of Invention

The present invention relates to a ceramic filter which is cylindrical and provided with slit-like aperture portions of given sizes at given positions in parallel with the direction of the flow paths of cells; that is, the long axial direction of the flow paths.

2. Related Art Statement

Ceramic filters (hereinafter sometimes referred to as merely “filters”) are excellent in that they are high in reliability because of their excellent physical strength and endurance as compared with high polymer membranes, etc., excellent also in corrosion resistance, and can be precisely controlled in pore diameter which determines filtering ability, and they are useful as filters for solid-liquid separation. As ceramic filters, there are generally used those which comprise a ceramics-made porous body (hereinafter sometimes referred to as “substrate”) having relatively large pores, the surface of which is covered with a ceramic filtration membrane having relatively small pores, for improving filtration performance while securing water permeation amount.

FIG. 2 is an oblique view which shows an example of ceramic filters. The filter 21 shown in FIG. 2 is a so-called monolithic filter comprising a cylindrical body 22 in which many parallel flow paths 23 are formed in the long direction of the cylindrical body, and a filtration membrane is formed on the inner peripheral surface of the flow paths 23, and said ceramic filter has a large filtration area per unit volume and a high filtration ability.

Recently, it has been attempted to make the monolithic filters larger in size for further improving the filtration ability thereof. However, the filtration ability of the large-sized filters have not been improved in filtration ability so much as expected due to their structure in which the liquid to be treated which is supplied to the flow paths (hereinafter may be referred to as “cells”) is filtered by a filtration membrane and the filtrate passes through the pores of a porous body and is discharged to the external space. The reason is considered that in the monolithic filters, the filtrate filtered through the flow paths in the vicinity of the central part of the porous body meets with larger fluid resistance when flowing out of the porous body and only the flow paths in the vicinity of the outer peripheral part of the porous body which meet with smaller fluid resistance are utilized for filtration, and therefore the substantial filtration area does not increase as compared with the area of the actually formed filtration membrane.

Under the circumstances, in an attempt to solve the above problems, there have been proposed ceramic filters in which water permeation amount from the flow paths in the vicinity of the central part of the substrate is increased by providing slit-like aperture portions (hereinafter sometimes referred to as merely “slits”) in the long axial direction of the porous body (JP-A-6-99039 and JP-B-6-16819). In these filters, since the filtrate filtered through the flow paths in the vicinity of the central part of the substrate is directly discharged from the slits to the external space, the distance of the filtrate passing through the inside of the substrate is shortened and the fluid resistance decreases. Therefore, the water permeation amount markedly increases and filtration ability is sharply improved. As these filters, mention may be made of, for example, ceramic filters shown in FIG. 3(a) and FIG. 3(b) and FIG. 4.

However, in the filter 31 shown in FIG. 3(a) and FIG. 3(b), slits 34 are provided in parallel in the form of a comb along the whole length of the cylindrical substrate 32, but since one end of the thin plate portion 32a between slits 34 is supported in the manner of cantilever by the central part 32b of the substrate, breakage during extrusion molding or handling or breakage caused by stress concentration during drying or firing cannot be inhibited, and it is difficult to obtain these filters. Furthermore, in the filter 41 shown in FIG. 4, slits 44 are provided in the vicinity of both end portions of the cylindrical substrate 42 in the long axial direction, and breakage during molding as in the filter 31 does not occur, but positions of slits in the long axial direction and opening area are not specified and the following two problems are caused. The first problem is that in case the length of slits 44 of the substrate 42 is long and the slits are provided in a certain range of the substrate in its long axial direction, the filter is sometimes deformed by firing strain to cause cracking. The second problem is that in case the length of slits 44 is short, sufficient water permeation performance cannot be obtained.

JP-A-2000-153117 proposes a ceramic filter in which the position of the slits provided is limited to only the middle part of the substrate in its long axial direction. It has been considered that deformation caused by the slits can be inhibited because the slits are provided at the middle part, not at the end part of the substrate. However, it is now recognized that the middle part in the long axial direction of the substrate deforms much during drying or firing depending on the raw materials used, and the compounding ratios of raw materials used, thereby resulting in cracking.

### SUMMARY OF THE INVENTION

The present invention has been made in an attempt to solve the above problems, and the object is to provide a ceramic filter which has a sufficient water permeation performance and can be inhibited from deformation and cracking caused by the slits during production without being influenced by the kind of raw materials used.

As a result of intensive research conducted by the inventors on the above problems, it has been found that the problems can be solved by specifying the opening area of the slits and specifying the position of providing the slits in a so-called monolithic filter, and the present invention has been accomplished.

That is, the present invention provides a ceramic filter comprising a cylindrical porous body which has many parallel flow paths formed in its long axial direction and is constructed so that the liquid to be treated which is supplied to the flow paths permeates through pores of the porous body and is discharged to the external space from the space defined by a neighboring flow path and in which a plurality of slit-like aperture portions are provided in the long axial direction of the porous body and the end portions of the flow paths communicating with the aperture portions are sealed, wherein all of the slit-like aperture portions are provided at such a position capable of satisfying the relations that the ratio Sn/Qn of opening area Sn (mm²) of each slit-like aperture portion and water permeation amount Qn (m³/day at 0.1 MPa, 25%) taken by the aperture portion having the opening are Sn is not less than 1.0 and the ratio D1/Lo of the whole length Lo of the porous body in its long axial direction and the distance D1 which is twice the shortest distance from the middle of the porous body in its long axial direction to the end of any one of a plurality of the slit-like aperture portions is not less than 0.5.

In the ceramic filter of the present invention, it is preferred that the slit-like aperture portions are provided communicating through from one end of the outer peripheral wall of the porous body to another end thereof, crossing over flow paths aligned in row, and both end portions of the respective flow paths which cross over the apertures are sealed, on one end side of the porous body in the long axial direction.

Furthermore, it is preferred that the slit-like aperture portions are provided communicating through only to one end of the outer peripheral wall of the porous body, crossing over flow paths aligned in row, and both end portions of the respective flow paths which cross over the apertures are sealed, on both sides of the porous body in its long axial direction.

Moreover, it is preferred that the slit-like aperture portions are provided communicating through from one end of the outer peripheral wall of the porous body to another end thereof, crossing over flow paths aligned in row, and both end portions of the respective flow paths which cross over the apertures are sealed, on both sides of the porous body in its long axial direction.

In the ceramic filter of the present invention, a filtration membrane having an average pore diameter smaller than the average port diameter of the porous body is formed on the inner peripheral surface of the flow paths, the liquid to be treated which is supplied to the flow paths is filtered by the filtration membrane and further permeates through the pores of the porous body and discharges into the external space, and the filtration membrane comprises at least one layer. This is because sufficient water permeation performance can be secured and a filter having a given pore diameter can be formed.

In the ceramic filter of the present invention, a plurality of slit-like aperture portions communicating with the flow paths, the end portions of which are sealed, are provided, and hence the filtrate filtered at the flow paths in the vicinity of the central part of the substrate is rapidly discharged from the aperture portions and the water permeation amount of the whole filter increases to remarkably improve the filtration ability. Moreover, since the slit-like aperture portion is specified in relation with the water permeation amount taken by each aperture portion and the individual opening area, the filtration ability is not damaged, and, furthermore, since the slit-like aperture is specified in relation with the whole length and the distance from the middle of the substrate (position of the slit-like aperture portion provided), occurrence of deformation and cracks due to the slits during production can be inhibited.

### BRIEF DESCRIPTION OF DRAWINGS

FIG. 1 is an oblique view which shows one embodiment of the ceramic filter of the present invention.

FIG. 2 is an oblique view which shows a monolithic filter as one example of ceramic filters.

FIG. 3(a) is an oblique view which shows one example of conventional ceramic filters, and FIG. 3(b) is a sectional view taken along the line A-A′ in FIG. 3(a).

FIG. 4 is an oblique view which shows another example of conventional ceramic filters.

FIG. 5(a) is an oblique view which shows one example of conventional ceramic filters, and FIG. 5(b) is an oblique view which shows one embodiment of the ceramic filter of the present invention.

FIG. 6 is an oblique view which shows one end peripheral part in one embodiment of the ceramic filter of the present invention.

FIG. 7 is an oblique view which shows one embodiment of the ceramic filter of the present invention.

FIG. 8 is an oblique view which shows one embodiment of the ceramic filter of the present invention.

FIG. 9 is an oblique view which shows one embodiment of the ceramic filter of the present invention.

FIG. 10 is a sectional view perpendicular to the long axial direction of the substrate in the portion where slits are formed in the ceramic filter shown in FIG. 7 and FIG. 9.

FIG. 11 is a sectional view perpendicular to the long axial direction of the substrate in the portion where slits are formed in the ceramic filter shown in FIG. 8.

FIG. 12 is a graph which shows relations between the water permeation amount Qo of the whole ceramic filter and the ratio Sn/On of the opening area Sn and the water permeation amount Qn taken by the slit-like aperture having the opening area Sn.

In the accompanied figures, the following referential numbers show the part, element, or portion as specified blow, respectively:
11, 21, 31, 41, 51, 52, 61, 71, 81, 91—filters
12, 22, 42, 72, 82, 92—substrates
14a, 14b, 14c, 74, 84, 94 slits.

### DETAILED DESCRIPTION OF THE INVENTION

The embodiments of the present invention will be explained referring to the drawings, but they should not be construed as limiting the present invention in any manner and various changes, modification and improvements can be made based on the knowledge possessed by one skilled in the art without departing the scope of the invention. For example, the drawings show suitable embodiments of the present invention, and the present invention is not limited by the embodiments shown in the drawings or the information shown in the drawings. For working and verifying the present invention, means similar or equivalent to those described in this specification are applicable, and suitable means are as explained below.

The ceramic filter of the present invention is a structural body comprising a cylindrical porous body (substrate) having many pores in which many parallel flow paths are formed in its long axial direction, and the liquid to be treated which is supplied to the flow paths permeates through the pores of the substrate and is discharged to the external space. As the substrate in the filter of the present invention, there is used a porous body having a relatively large pore diameter of 1 to a few hundred μm. This is because the filtration function is entirely performed by the filtration membrane formed on the surface of the substrate, and hence it is preferred that the pore diameter of the substrate per se is large to increase the water permeation amount of the filter.

As materials of the substrate, ceramics are used, and the kind of the ceramics is not particularly limited. There may be optionally selected, for example, from alumina, titania, mullite, zirconia, and mixtures thereof, considering corrosion resistance against liquids to be treated or cleaning solutions, easiness in production, cost, purpose, etc.

The shape of the substrate is not particularly limited, and may be such that the shape of the section perpendicular to the long axial direction is, for example, circular, elliptic, oval, triangular and tetragonal, but cylindrical body having a circular section is especially suitable because it is easy in production by extrusion molding, less in deformation by firing and easy in sealing to a housing.

The size of the substrate is not particularly limited, and when the substrate is a cylindrical body, one which has an outer diameter of 50 mmφ or more is especially preferred. The problem of fluid resistance is caused when the substrate is large-sized and the distance from the central part to the outer peripheral part of the substrate is long, and the problem hardly occurs for a small filter in which the distance from the central part to the outer peripheral part of the substrate is short. For example, in the case of a substrate of less than 50 mmφ in outer diameter, the fluid resistance in the substrate hardly causes problems and there are less necessity and no benefit in providing the slits. The outer diameter is more preferably 100 mmφ or more and further preferably 150-200 mm φ. The whole length of the substrate in its long axial direction is usually about 150-2000 mm. The whole length in the long axial direction is more preferably 500 mm or more, further preferably 1000-2000 mm. In this specification, the term “central part (the central part of substrate)” means the approximately central part in the short axial direction of the substrate (the sectional direction approximately perpendicular to the long axial direction), and this is expressed relatively to the outer peripheral surface and the scope of the central part is not limited only by this expression. The term “middle part” means approximately middle part of the substrate in the long axial direction and this is expressed relatively to the end part and the scope of the middle part is not limited only by this expression. The term “middle” means the position at ½ of the substrate in the long axial direction and the position is limited only by this expression.

As the substrate, there can be used a so-called honeycomb structural body which is a structural body having many parallel cells formed in its long axial direction. The shape of the section of the cells is not particularly limited, and is preferably circular because solid matters deposited on the surface of membrane can be easily peeled and removed by back washing and tetragonal or hexagonal because the filtration area per unit volume of the substrate can be made larger. The diameter of the cells may be selected depending on the properties of the liquid to be treated (solid concentration, size of the solid, viscosity, etc.) for securing the filtration area per unit volume, easily peeling the deposited solid matters during back washing, reducing the water permeation resistance of filtrate in the substrate, and the like. For example, when the filter is used for filtration of tap water, the diameter of the cells is preferably about 1-5 mm. In order to secure the strength of the substrate, it is preferred that the opening volume of all the cells is preferably 80% or less of the volume of the substrate.

In the ceramic filter of the present invention, it is preferred that a filtration membrane having a pore diameter smaller than that of the substrate is formed on the inner peripheral surface of the cells. The liquid to be treated which is supplied to the cells is first filtered with the filtration membrane, then permeates through the pores and is discharged into the external space. Such ceramic filter is larger than plate-like or tubular filtration membranes in filtration area per unit volume and is superior because of its high filtration ability. The filtration membrane is comprised of ceramics like the substrate and is a thin membrane of several ten μm or less in pore diameter. The filtration membrane can be formed by producing a membrane from slurry containing ceramic particles on the inner peripheral surface of the substrate and firing the membrane to stick it to the substrate. The pore diameter of the filtration membrane can be controlled by the particle diameter of the ceramic particles. The ceramic particles are not particularly limited, and there may be used, for example, alumina (Al₂O₃), titania (TiO₂), mullite (Al₂O₃SiO₂), zirconia (ZrO₂), silica (SiO₂), spinel (MgO—Al₂O₃), and mixtures thereof. It is preferred to employ materials of high corrosion resistance (e.g., alumina) because raw materials controlled in particle diameter are easily available and stable slurry can be obtained. The ceramic particles are dispersed in a dispersion medium such as water and, if necessary, an organic binder, a pH adjustor, a surface active agent and the like are added to the dispersion to prepare slurry for the membrane formation. Using the slurry, a membrane is formed on the inner peripheral surface of the substrate by conventionally known method such as dip membrane forming method and dried, and furthermore the resulting membrane is fired at a high temperature of about 1300° C., whereby a filter can be made.

The ceramic filter of the present invention comprises a so-called monolithic substrate having slit-like aperture portions, characterized in that the slit-like aperture portions are specified in the relation of the water permeation amount taken by each aperture portion and the individual opening area of the aperture portions and the position of the slit-like aperture portions is specified in the relation of the distance from the middle of the substrate and the whole length of the substrate. That is, in the filter of the present invention, the slit-like aperture portions having a size limited to a specific range in relation with the water permeation amount taken by each aperture portion are provided at a position limited in a specific range in relation with the whole length in the long axial direction of the substrate. So long as these conditions are satisfied, the shape, number, width and position of the slits are not particularly limited and are optionally determined considering strength of the substrate and easiness in working of the substrate.

In the ceramic filter of the present invention, the slits are provided so that the ratio (Sn/Qn) of the opening area Sn (mm²) of individual slit and the water permeation amount Qn (m³/day at 0.1 MPa, 25° C.) taken by the slit having an opening area Sn is 1.0 or more. The term “water permeation amount taken by slit” means the amount of water discharged when a liquid to be treated which is supplied to the cells is filtrated with the filtration membrane, permeates through pores of the substrate and is discharged through the slit to the external space.

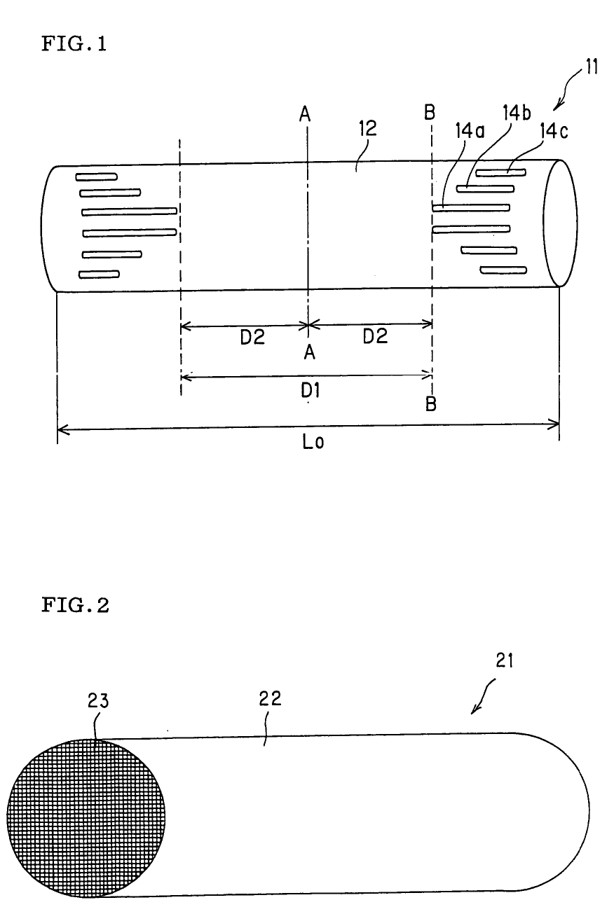

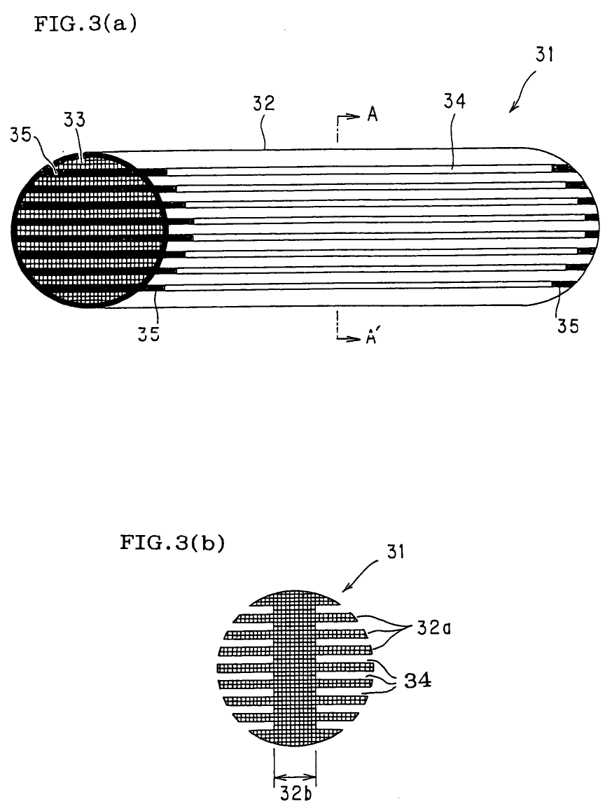

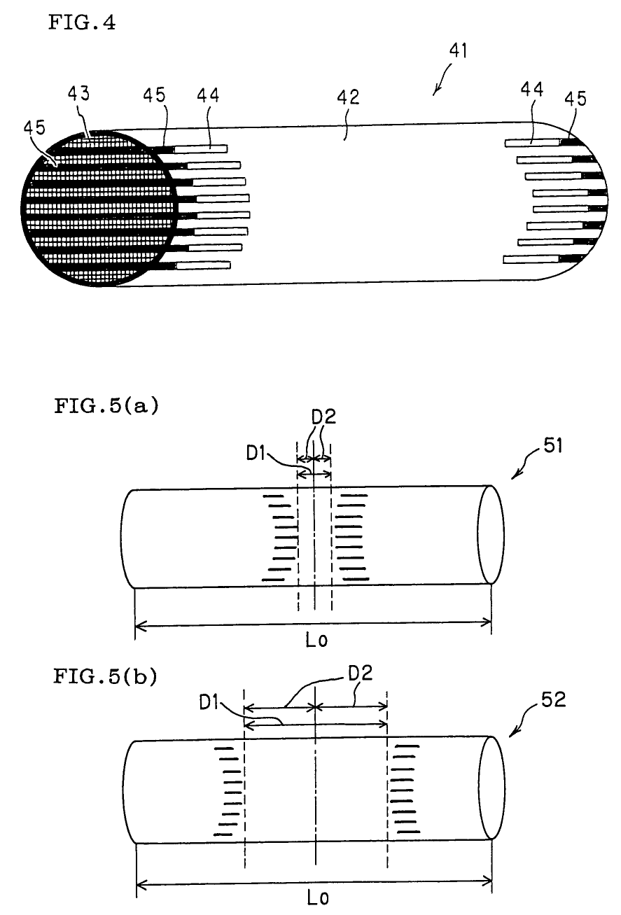

FIG. 1 is an oblique view showing an embodiment of the ceramic filter of the present invention. In the filter 11 shown in FIG. 1, the opening area S1 of slit 14a (mm², length of slit 14a×width of slit 14a) and the water permeation amount Q1 taken by the slit 14a satisfy S1/Q1≧1.0, the opening area S2 of slit 14b (mm², length of slit 14b×width of slit 14b) and the water permeation amount Q2 taken by the slit 14b satisfy S2/Q2≧1.0, and the opening area S3 of slit 14c (mm2, length of slit 14c×width of slit 14c) and the water permeation amount Q3 taken by the slit 14c satisfy S3/Q3≧1.0, and thus for all the slits, opening area Sn and water permeation amount Qn satisfy Sn/Qn≧1.0.

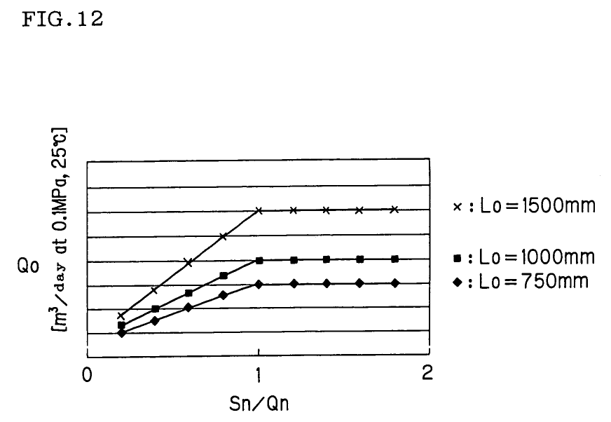

FIG. 12 is a graph which shows the relation between the water permeation amount Qo of the whole ceramic filter (m³/day at 0.1 MPa, 25° C.) and the ratio Sn/Qn of the opening area Sn and the water permeation amount Qn taken by the slit having the opening area Sn in three ceramic filters of 750 mm, 1000 mm and 1500 mm in the whole length Lo of the substrate. Specifically, this graph is prepared in the following manner. First, a ceramic filter having a whole length Lo of 750 mm and having a plurality of slits, all of which are sufficiently long, is prepared, and water permeation amount Qo of the whole ceramic filter is measured and water permeation amount Qn of each slit is calculated from the number of cells in charge. Based on this Qn, slits are made in ceramic filters of the same whole length (the same construction) so that the opening area Sn satisfies Sn/Qn=0.2 for all the slits, and the water permeation amount Qo of the whole ceramic filter is measured. In the same manner, slits are made in the ceramic filters so as to give Sn/Qn=0.4, Sn/Qn=0.6, Sn/Qn=0.8, Sn/Qn=1.0, Sn/Qn=1.2, Sn/Qn=1.4, Sn/Qn=1.6, and Sn/Qn=1.8, and each water permeation amount Qo of the whole ceramic filter is measured. The resulting water permeation amounts Qo are plotted to obtain a curve of Lo=750 mm in FIG. 12. The curves of Lo=1000 and Lo=1500 mm in FIG. 12 are also obtained in the same manner as mentioned above.

As is clear from FIG. 12, in all of the three ceramic filters in which the whole length of the substrate is 750 mm, 1000 mm and 1500 mm, in the case of Sn/Qn≧1.0, each curve in the graph is horizontal, which means that the water permeation performance of the ceramic filters is fully exerted. On the other hand, in the case of Sn/Qn<1.0, the whole water permeation amount Qo increases with increase of opening area Sn of the slit, namely, with increase of Sn/Qn, which means that the slits determine the whole water permeation amount. Therefore, when all of the slits satisfy Sn/Qn≧1.0, loss of filtration ability caused by insufficient opening area of the slits can be inhibited.

Furthermore, in the ceramic filter of the present invention, all the slits are provided at the position where the ratio D1/Lo of the whole length Lo of the substrate in its long axial direction and the distance D1 which is twice the shortest distance between the middle of the substrate in its long axial direction and the end of any one of a plurality of the slit-like apertures is 0.5 or more.

In the filter 11 shown in FIG. 1, the slit provided at the position nearest to the middle of the substrate 12 in the long axial direction is slit 14a, and hence the distance D1 corresponds to the distance which is twice the shortest distance D2 between the middle of the substrate 12 in the long axial direction (the position of the section AA in FIG. 1) and the end of the slit 14a (the position of the section BB in FIG. 1), and satisfies D1/Lo≧0.5 in relation with the whole length Lo of the substrate in its long axial direction. In the filter 11, the distance D1 is shown as the shortest distance between the slits on both end sides of the substrate 12 in the long axial direction. This is because the slits are provided symmetrically on both end sides of the substrate in its long axial direction, but in the ceramic filter of the present invention, a plurality of the slits may not necessarily be provided symmetrically on both end sides of the substrate in its long axial direction and the distance D1 does not always show the shortest distance between the slits on both end sides, but the distance D1 is twice the distance D2.

FIG. 5(b) is an oblique view showing one embodiment of the ceramic filter of the present invention, and FIG. 5(a) is an oblique view showing a conventional ceramic filter deviating from the requirements of the present invention. The filters 51 and 52 shown in FIG. 5(a) and FIG. 5(b) both have a plurality of slits of the same length. In the filter 52, the positions of the slits are closer to the middle of the substrate than those in the filter 11 (FIG. 1), but since the relation D1/Lo≧0.5 is satisfied, cracks hardly occur during the firing in production of the filter. On the other hand, in the filter 51, since the positions of the slits are too close to the middle of the substrate and the relation D1/Lo≧0.5 is not satisfied, cracks are apt to occur during the firing in production of the filter.

Table 1 shows the degree of cracking in the three kinds of ceramic filters having the whole length Lo of the substrate of 750 mm, 1000 mm and 1500 mm which were produced with changing the positions of the slits in the respective ceramic filters. In Table 1, “◯” means that no cracks occurred and “X” means that cracks occurred. In this example, the slits, all of which had the same length, were formed at the same positions among the three kinds of the ceramic filters. As can be seen from the results shown in Table 1, no cracks occurred in the ceramic filters where all of the slits were provided at such positions that the ratio D1/Lo of the whole length Lo of the substrate and the distance D1 which is twice the shortest distance between the middle of the substrate in the long axial direction and the end of slits is 0.5 or more, while cracks occurred in the ceramic filters where the slits were provided at such positions as the ratio D1/Lo being less than 0.5.

TABLE 1

| Lo | D1/Lo | | | |
|---|---|---|---|---|
| [mm] | 0.2 | 0.4 | 0.5 | 0.75 |
| 750 | X | X | ◯ | ◯ |
| 1000 | X | X | ◯ | ◯ |
| 1500 | X | X | ◯ | ◯ |

In the ceramic filter of the present invention, since the slits are provided at the substrate and thus a part of cells are broken, the end portions of the cells communicating with the slits (opening portions of the end of the substrate) are air tightly sealed so as not to cause contamination of the filtrate due to the incorporation of the liquid to be treated. Sealing of the cells can be performed, for example, by filling up the end portions of the cells with filler comprising the same material as the substrate and then covering the end face of the substrate with a glassy material and firing it to perform sealing of the cells. The filler and the sealing material may be the same (e.g., a glassy material).

It can be considered to provide the slits radially in respect to the cylindrical body, but it is preferred to provide in such a manner that a plurality of the slits are in parallel with each other because the distances from the respective cells in the filter to the external space are nearly equal and the water permeation amounts of all the cells are nearly the same. Therefore, it becomes possible to effectively utilize all the cells in the filter and uniformly filter the liquid. Moreover, since when back washing is carried out, uniform back pressure can be applied to each cell, uniform back washing can be performed and clogging of a part of the cells can be inhibited.

In the ceramic filter of the present invention, it is preferred that a plurality of the slits provided at the cylindrical substrate in its long axial direction has different length, but the present invention is not limited to this embodiment. It is especially preferred that the length of the slits becomes gradually shorter from the portion where the length of the cells communicating with the slits and sealed at their both end portions in the short axial direction of the substrate is longer (slits communicating with the central part) to the portion where the length of the cells communicating with the slits and sealed at their both end portions in the short axial direction thereof is shorter (slits communicating with the outer peripheral part).

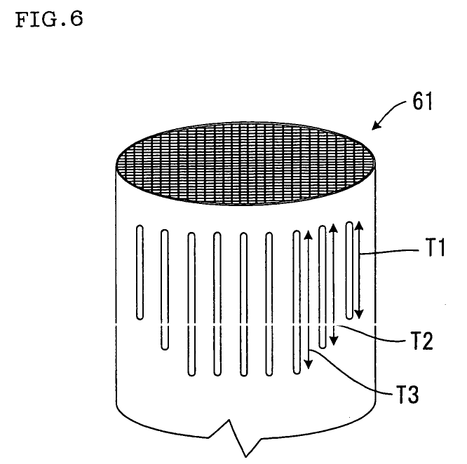

FIG. 6 is an oblique view which shows one end side of the ceramic filter which is one embodiment of the present invention. In the filter 61 shown in FIG. 6, the five slits communicating with the central part have the longest length of T3 among the nine slits, and the length of the slits communicating with the outer peripheral part gradually decreases to T2 and T1. The reason why this embodiment is preferred is that the slits on the outer peripheral side and those on the central side differ in the number of cells covered by the respective slits, and by balancing the number of the cells covered by the respective slits and the length of the slits, the slits on the outer peripheral side which are most readily broken at handling becomes shorter, and as a result, reduction of strength caused by providing the slits can be minimized. Furthermore, by allowing the slits on the outer peripheral side to be shorter, deformation during firing can be inhibited and the trouble of making the slits can be saved.

Furthermore, the end portions of the slit-like apertures are preferably R-shaped because when stress is applied to the slits, occurrence of cracks which are apt to occur at the edge portion of the slits having smaller curvature can be inhibited.

In the ceramic filter of the present invention, the slits-like aperture portions may be provided on one end side or both end sides of the substrate in its long axial direction. Moreover, the slits may be provided communicating through from one end of the outer peripheral wall of the porous body to another end thereof, crossing over flow paths aligned in row, and both end portions of the respective flow paths which cross over the apertures are sealed; or provided communicating through only to one end of the outer peripheral wall of the porous body crossing over flow paths aligned in row, and both end portions of the respective flow paths which cross over the apertures are sealed.

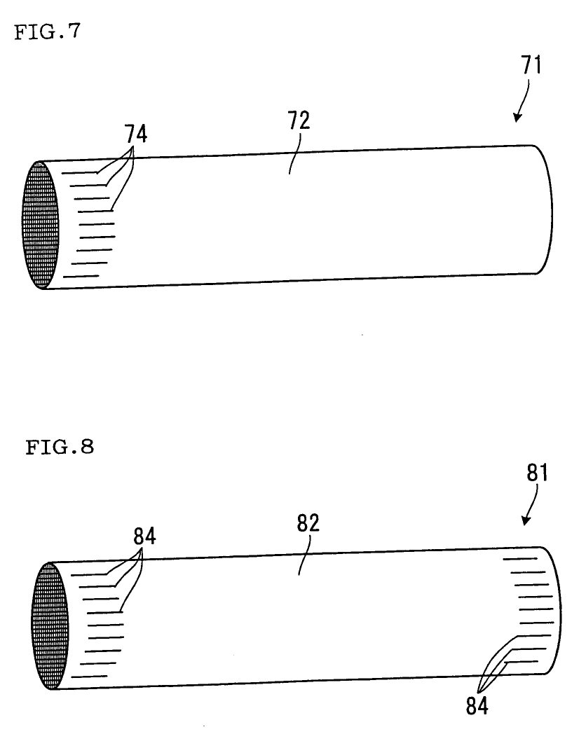

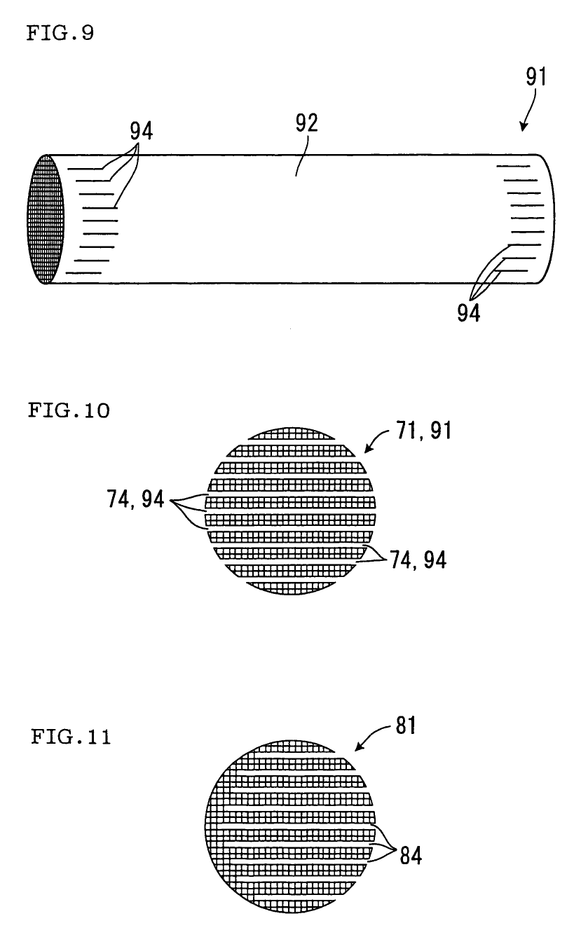

FIG. 7 is an oblique view showing one embodiment of the ceramic filter of the present invention. FIG. 10 shows a section of the substrates 72 and 92 perpendicular to the long axial direction in the portion of the ceramic filters 71 and 91 (filter 91 will be explained hereinafter) shown in FIG. 7 and FIG. 9 in which slits 74 and 94 are formed. In the filter 71 shown in FIG. 7, slits 74 are provided on one end side of the substrate 72 in its long axial direction (on the left side of the substrate in FIG. 7) and communicate through from one end of the outer peripheral wall of the porous body to another end thereof, crossing over flow paths aligned in row, and both end portions of the respective flow paths which cross over the apertures are sealed (see FIG. 10). That is, slits appearing in FIG. 7 communicate through to the corresponding other end of the outer peripheral wall of the substrate while they are not shown in FIG. 7.

FIG. 8 is an oblique view showing one embodiment of the ceramic filter of the present invention. FIG. 11 shows a section of the substrate 82 perpendicular to the long axial direction in the portion of the ceramic filters 81 shown in FIG. 8 in which slits 84 are formed. In the filter 81 shown in FIG. 8, slits 84 are provided on both end sides of the substrate 82 in the long axial direction (on both the left and right sides of the substrate in FIG. 8) and communicate through only to one end of the outer peripheral wall of the porous body, crossing over flow paths aligned in row, and both end portions of the respective flow paths which cross over the apertures are sealed (see FIG. 11). That is, the slits only communitcate through to only one end of the outer peripheral wall of the porous body, crossing over flow paths aligned in row. That is, the slits 84 appearing in FIG. 8 communicate through only to the outer peripheral wall of the porous body, but not to the corresponding other end of the outer peripheral wall.

FIG. 9 is an oblique view showing one embodiment of the ceramic filter of the present invention. In the filter 91 shown in FIG. 9, slits 94 are provided on both end sides of the substrate 92 in the long axial direction (on both the left and right sides of the substrate in FIG. 9) and communicate through from one end of the outer peripheral wall of the porous body to another end thereof, crossing over flow paths aligned in row, and both end portions of the respective flow paths which cross over the apertures are sealed (see FIG. 10). That is, the slits 94 appearing in FIG. 9 communicate through to the corresponding other end of the outer peripheral wall of the substrate while they are not shown in FIG. 9.

The ceramic filters of the present invention can be suitably used, for example, as various filters for removing suspended materials, bacteria, dusts, etc. in liquid in the fields of water treatment, medicines, foods, etc.

1. A ceramic filter comprising a cylindrical porous body which has many parallel flow paths formed in long axial direction of the porous body and is constructed so that a liquid to be treated which is supplied to the flow paths permeates through pores of the porous body and is discharged to an external space from a space defined by a neighboring flow path and in which a plurality of slit-like aperture portions are provided in the long axial direction of the porous body and both end portions of the respective flow paths communicating with the aperture portions are sealed, where all of the slit-like aperture portions are provided at such positions capable of satisfying the relations that a ratio Sn/Qn of opening area Sn (mm²) of each slit-like aperture portion and water permeation amount Qn (m³/day at 0.1 MPa, 25° C.) taken by the aperture portion having the opening area Sn is not less than 1.0 and a ratio D1/Lo of the whole length Lo of the porous body in the long axial direction and a distance D1 which is twice the shortest distance from a middle of the porous body in the long axial direction to an end of any one of a plurality of the slit-like aperture portions is not less than 0.5.

2. A ceramic filter according to claim 1, wherein on either one end side of the porous body in its long axial direction, the slit-like aperture portions are provided communicating through from one end of an outer peripheral wall of the porous body to another end thereof, crossing over flow paths aligned in row, and both end portions of the respective flow paths which cross over the apertures are sealed.

3. A ceramic filter according to claim 1, wherein on both end sides of the porous body in its long axial direction, the slit-like aperture portions are provided communicating through only to one side of an outer peripheral wall of the porous body crossing over flow paths aligned in row, and both end portions of the respective flow paths which cross over the apertures are sealed.

4. A ceramic filter according to claim 1, wherein on both end sides of the porous body in its long axial direction, the slit-like aperture portions are provided communicating through from one end of an outer peripheral wall of the porous body to another end thereof, crossing over flow paths aligned in row, and both end portions of the respective flow paths which cross over the apertures are sealed.

5. A ceramic filter according to claim 1 which further comprises at least one layer of a filtering membrane whose average pore diameter is smaller than that of the porous body, and said membrane is formed on an inner surface of flow paths.

6. A ceramic filter according to claim 2 which further comprises at least one layer of a filtering membrane whose average pore diameter is smaller than that of the porous body and said membrane is formed on an inner peripheral surface of flow paths.

7. A ceramic filter according to claim 3 which further comprises at least one layer of a filtering membrane whose average pore diameter is smaller than that of the porous body and said membrane is formed on an inner peripheral surface of flow paths.

8. A ceramic filter according to claim 4 which further comprises at least one layer of a filtering membrane whose average pore diameter is smaller than that of the porous body, and said membrane is formed on an inner peripheral surface of flow paths.
